(19) United States
(12) Patent Application Publication
(10) Pub. No.: US 2004/0002911 A1
(43) Pub. Date: Jan. 1, 2004

(54) Method for the electronic processing of share transactions

(76) Inventor: Peter Seilern, Lausanne (CH)

Correspondence Address: Clifford W. Browning, Woodard, Emhardt, Naughton, Moriarty & McNett, Bank One Center/Tower, 111 Monument Circle, Suite 3700, Indianapolis, IN, 46204-5137, US

(21) Appl. No.: 10/184,311

(22) Filed: Jun. 27, 2002

(51) Int. Cl. G06F 17/60

(52) U.S. Cl. 705/37

(57) ABSTRACT

Method of trading securities electronically, each security is defined by its symbol (S1, S2) and its quotation value (P1, P2, P3, P4), of a first security (S1) to be sold at a first initial quotation value (P1) with a defined initial quantity (N1) which represents a first initial global value (P1*N1) at a reference point, wherein it comprises the following steps: a) definition of a second security (S2) to be acquired, for which one specifies a second quantity (N2) at a second initial quotation value (P2) representing a second initial global value (P2*N2) reference point; b) definition of a trading condition (RS) representing a gain resulting from the sale of the first quantity (N1) of the first security (S1) and the purchase of the second quantity (N2) of the second security (S2) after an evolution in the time of the quotation values of the first and second security, allowing this gain (RS) to be realized, having understood that this gain would have been zero if the transaction had been conducted at the reference point; c) monitoring of the current quotation value (P3) of the first security and the current quotation value (P4) of the second security; d) calculation of the fictitious gain (AS) resulting from the sale of the first quantity (N1) at the current quotation value (P3) of the first security (S1) and of the purchase of the second quantity (N2) at the current value (P4) of the second security (S2); e) if this fictitious gain (AS) is equal to, or exceeds, the value of the trading condition (RS), verification that all or part of the quantity (N1) of the first security is actually required by the bid market and if all or part of the second quantity (N2) of the second security is available on the ask market, and in the positive event; f) simultaneous sale of all or part of the first quantity (N1) of the first security (S1) and purchase all or part of the second quantity (N2) of the second security (S2), and g) in the negative event, re-execute steps c) to e).

This application relates to transactions of stocks and shares and in particular to transactions conducted electronically.

Since the end of the 1990s, the possibilities of conducting share transactions electronically have led to an explosion in the number of daily transactions. In March 2001, there were more than 13 million users registered who were dealing in buying or selling orders over the internet.

This success is due to the access to online share information and the ease of placing orders. Another important aspect of this craze has been the continual reduction in commission rates on the deals. An account opened with an online broker is sufficient to transform a family-father into an armchair expert on the rates and values of the stock market.

There have even been cases of people leaving their jobs in order to devote themselves entirely to this activity with all the inherent risks involved.

When analysing the evolution of a security, three scenarios are generally considered: the short, the medium and the long term.

A security that is considered to be long term, is a security that evolves in accordance with the health of the business concerned. As far as the medium term is concerned, the value of the security is generally linked to the global evolution of the stock exchange. As for the short term (several days to several weeks) its evolution is unpredictable and depends on many factors such as individual purchasing and selling decisions, research and investigations into the markets, the economy, the political situation, rumors, the interest in a sector, etc.

If one were to examine a quotation value of a security more closely, it would be noted that it is subject to many random fluctuations often of several percent which vary according to the volatility of the particular security.

The parameters for this invention are only concerned with the processing of securities in the short term.

All the transaction platform suppliers are endeavoring to make their access propositions as attractive as possible by offering transaction support tools. The systems that allow the user to select a security and to define its limits, thereby activating orders, are well known.

If for example, I purchased a security for $25, and I placed an order limit on the sale of $28 and this security reached this limit, the sale of the security would yield me $3 per security. Once the data is validated and transmitted to the brokerage platform, there is nothing left to do except to wait for the moment when my security reaches the pre-fixed limit.

It could happen that this order is placed whilst the market is experiencing a rise, and although yielding me $3, ths security could have been sold for $32 several days later.

In accordance with another method of online brokerage described in the document WO 0051043, it is possible to process a large number of securities automatically. The conditions are applied across the board and apply to several transactions.

From what is known about the methods deployed for this type of technique as described above, although they do simplify the stages required for conducting a transaction to a large extent, what they all have in common is the fact that they are linked to a security itself and do not take into account the economic environment at the moment of the purchase or the sale.

The purpose of this invention is to make a tool available to users that will enable them to take into account the short-term evolution of the value of the securities in question.

This objective is achieved by a method of trading securities electronically, each security is defined by its symbol (S) and its quotation value (P1, P2, P3, P4), of a first security (S1) to be sold at a first initial quotation value (P1) with a defined initial quantity (N1) which represents a first initial global value (P1*N1) at a reference point, wherein it comprises the following steps:

a) definition of a second security (S2) to be acquired, for which one specifies a second quantity (N2) at a second initial quotation value (P2) representing a second initial global value (P2*N2) reference point,

b) definition of a trading condition (RS) representing a gain resulting from the sale of the first quantity (N1) of the first security (S1) and the purchase of the second quantity (N2) of the second security (S2) after an evolution in the time of the quotation values of the first and second security, allowing this gain (RS) to be realized, having understood that this gain would have been zero if the transaction had been conducted at the reference point,

c) monitoring of the current quotation value (P3) of the first security and the current quotation value (P4) of the second security,

d) calculation of the fictitious gain (AS) resulting from the sale of the first quantity (N1) at the current quotation value (P3) of the first security (S1) and of the purchase of the second quantity (N2) at the current value (P4) of the second security (S2),

e) If this fictitious gain (AS) is equal to, or exceeds, the value of the trading condition (RS), verification that all or part of the quantity (N1) of the first security is actually required by the bid market and if all or part of the second quantity (N2) of the second security is available on the ask market, and in the positive event,

f) simultaneous sale of all or part of the first quantity (N1) of the first security (S1) and purchase all or part of the second quantity (N2) of the second security (S2),

g) in the negative event, re-execute steps c) to e).

By “security” we are referring to all types of “values” that are traded on the electronic stock market, including shares, bonds/debentures, options, derivatives, warrants, investment funds, currencies etc.

The method of the invention consists, therefore, of monitoring the evolution of two securities, one S1 in view of the sale and the other S2 in view of the purchase. This monitoring can either be based on the unitary value of each security, or on the global value of the securities under consideration, or in percentage terms as regards the reference point.

At the reference point, a fictitious value is considered at which the sale of the S1 securities and the purchase of the S2 securities, in accordance with the pre-defined quantities N1 and N2 would take place. This transaction would not leave any residual value because the two initial global values are identical. On the other hand the two global values could be different if there had been an initial difference that could either have been positive or negative. Nevertheless, it is considered that this difference does not constitute a gain since it relates to the conditions at the point of reference.

The original trading condition is defined according to the following formula:

RS=S*(N1*P1+N2*P2)/2

S is the desired performance expressed as a percentage and RS is the desired gain expressed as an absolute value. Currently the average value between the global sales value and the global purchase value is used.

For every security, at any moment in time, there are many parameters that express its quotation value. As far as its value is concerned, it is possible to obtain the value of the last transaction, the average daily volume, the bid price and the ask price.

This invention is not restricted to using only one or other of these values. The choice of value selected to carry out the gain calculations depends on how the invention is implemented and the accuracy that one wants to obtain.

According to the invention's preferred model, it is particularly the bid price and the ask price at the precise moment of the evaluation of the security's current value that concerns us. For the remainder of this document, the current value of the bid price will be referred to as P3 and the current value of the ask price will be referred to as P4. For the calculation of the initial value of the securities in question (P1 and P2), it is possible to utilize the value of the last transaction for that security or the current bid price (P1) or the current value of the ask price (P2).

When the transaction takes place, the real gain (AS) can be expressed by the following formula:

AS=(N1*P3−N2*P4)−(N1*P1−N2*P2)

This method has many advantages. After a double transaction, there is a gain that is proportional to the variation of the evolution of the two securities under consideration and the quantity involved in the transaction.

This method enables the smallest variations in the evolution of the securities to be taken into account. In fact, studies have shown that a difference of up to 2-3% can often occur in the first few days between two known shares with supplementary conditions of availability (ask) and demand (bid),

A longer period will be required if one wishes to register larger differences. This period will also depend on the volatility of the stock markets.

The fact of verifying simultaneously the two conditions, ie. both the sale and the purchase conditions, means that one will never find oneself in a tricky situation. In a classic scenario, one sells the securities first and then looks to buy other securities. The period of time between these two activities and the volatility of the markets can mean that favorable conditions can rapidly be overturned and the user has to wait a long time before seeing the value of his targeted security rise again to the desired level.

Therefore, it is very difficult—without using the methodology of this invention—to take advantage of the rapid, uncertain variations in securities.

To calculate a relative value, there must be a reference point. In accordance with a first implementation, the initial value of the first and second security is entered when the data is input into the online brokerage system

Many user-assistance tools are envisaged to surround this method which will be described below in detail. They will refer to the following example diagrams (figures) ie:

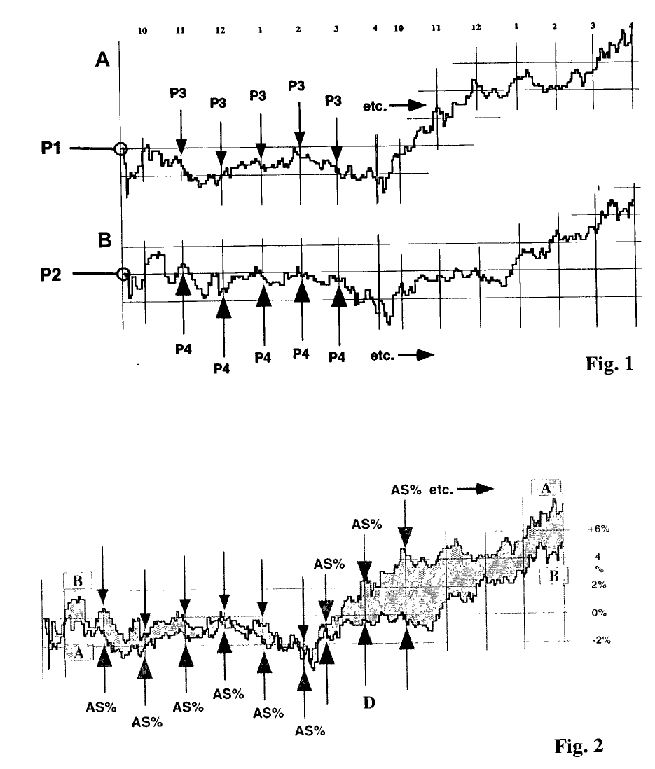

FIG. 1 illustrates the quotation value of two known shares.

FIG. 2 illustrates the comparative quotation value of the two shares.

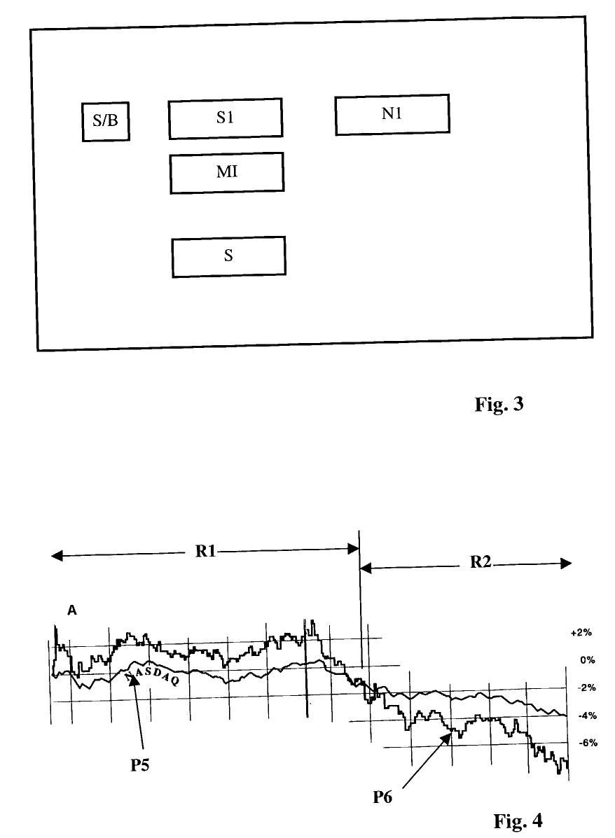

FIG. 3 illustrates a data entry form for the data in accordance with the method of entering the share and the index.

FIG. 4 illustrates the evolution of a security as regards the index.

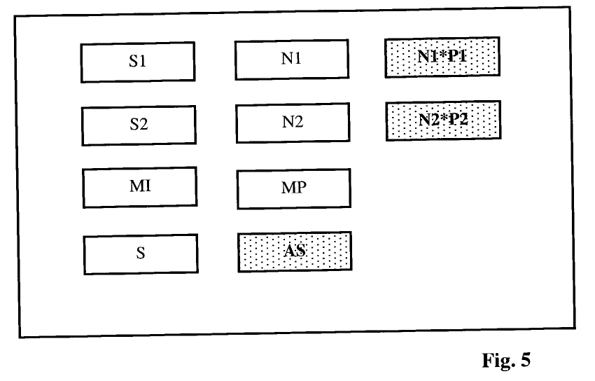

FIG. 5 illustrates a combination model of two securities and one index.

FIG. 1 shows the quotation value of a first security A and a second security B over a period of a day. The value of each of these securities can be very different. It can be observed that over time the variations are rapid and random. In this example, the points P3 pinpoint the actual moments when there has been an electronic data reading of security A. Therefore, the value P3 represents the instant value of this security. In the same way, the points P4 pin-point the actual moment when there has been an electronic data reading of security B. These values will therefore be used to calculate the global value of each security based on the quantity determined by the user for each security.

In order to fully understand this monitoring function of the two shares, A et B, FIG. 2 illustrates the relative variations between the two securities.

In our example, the user wants to sell A securities in order to purchase B securities. The AS points represent the moments when the potential gain is calculated based on the instant values of P3 and P4 and the respective quantities N1 and N2. According to this example, the AS gain is calculated every hour.

It can be noted that the relative evolution of the two curves will cause them to cross. The trend where security B was performing better than security A is reversed and it is security A that has a better performance than security B.

When the AS value is equal to or greater than the trading condition RS, as illustrated at point D, a double transaction can take place if all the other conditions are fulfilled, ie the A securities are demanded by the market and the B securities are available on the market.

When performing data entry, the user will enter the definition of the security that he wants to sell (S1). This security is generally identified by its stock market code. Once the security has been selected, the quantity of securities N1 also has to be determined. Based on these two pieces of information, the sales value is calculated according to the quotation value of the day (P1).

Similarly, the data for the security to be purchased (S2) are specified by the user inputting its stock market code. The quantity N2 targeted by this purchase and the global value of the purchase is calculated and displayed in the field (N2*P2) according to the quotation value of the day (P2).

The trading condition S still has to be specified in order for the double transaction to take place. According to one implementation method, this condition is specified in percentage terms and varies between 0.5-10%, maybe even more. Once these values have been entered, the progamme can calculate the supposed RS gain resulting from the sale of security S1 and the purchase of security S2 after the trading condition has been reached. This value is displayed on the screen.

Many user-instigated errors can of course occur and for this reason the progam has built-in certain verification checks.

A control on the designation of the securities (S1, S2). It is important that the code is correct and actually exists in the list of stock market codes.

A control on the availability of the security to be sold within the portfolio of the principal. The specified quantity to be sold is also verified in order to avoid introducing conditions that are impossible to fulfill.

A control regarding the comparison of the two global values in order that the exchange of a security by another retains a similar value. If these values differ greatly, a warning is displayed on the screen to alert the user. A different quantity is then proposed to the user which corresponds to the value of the sale.

A control regarding the supposed performance criteria S. It is verified to see if the performance criteria S falls within acceptable limits. If the user decides on a rate of 100%, it is useful to warn him that this is unlikely ever to occur.

These verifications infer that recent data on securities can be accessed by the data entry orders application. The procedure has two phases: the first phase introduces values such as stock market codes, quantity and performance.

The second phase results in the verification by the application of the entered data and it returns the global transaction values (N1*P1 and N2*P2) and the supposed value of the RS gain.

It is possible, in one variation of the invention, to only determine the sales conditions, both of the security and the quantity, and the security to acquire and its performance. The software application specifies the quantity to purchase so that the global value of the two transactions are approximately equivalent.

The user sends his order and receives on return a complete image of the transaction for his verification and confirmation.

Once the transaction has been validated by the user, it is stored in the operator's database and the monitoring begins.

In one implementation method of the invention, the frequency of the monitoring depends on the result of the comparison between the two securities. If the quotation values indicate that the trading condition is remote, then the frequency can be low, for example every 15 minutes. The closer one gets to the trading condition, the shorter the time-period between the two verifications.

The advantage of this process is that it does not overload the online quotation value query process unnecessarily.

Within the parameters of this invention, it is also envisaged that measures should be taken if the quotation values diverge beyond a pre-defined threshold. For example, if the two securities being monitored diverge by more than 5% (this value can be defined by the user), a message will be sent to that effect to inform the user. And he can cancel his order if he wishes.

One scenario could be that the performance conditions are met but that the quantities of securities offered and requested are not available either for one or both of the desired securities.

In one iteration of the invention, it is possible to sub-divide the transaction, thereby maintaining an equivalent purchase and sales value. If the initial condition was to sell N1 of A securities (eg 1500 securities) and to purchase N2 of B securities, (eg 1000 securities) it is possible that if only a part of this quantity of N1′ is available (eg 600 B securities), the transaction will be carried out on the sale of the N1′ A securities (900 securities) and the purchase of N2′ B securities (600 securities).

Following this transaction, the monitoring of the criteria continues with the aim of carrying out the outstanding balance of this order ie. to sell 600 A securities and to purchase 400 B securities.

In practice, if only 10 B securities were available, the transaction would be blocked by in-built controls to avoid transactions being conducted purposelessly, for example by defining the minimum percentage of the targeted quantity. If such a percentage had been fixed at 30%, according to our example, a minimum of 450 A securities would have been required and 300 B securities would have to have been available for the transaction to be carried out.

In FIG. 3, only a security that one would like to purchase or sell is considered. Unlike other well-known systems that use high and low limits to launch the order, the invention's solution proposes a comparison of the evolution of a security with the evolution of a market index.

The security to be sold or purchased is entered in the field S1. The function purchase/sale is defined in the field S/B. The user specifies the quantity of securities to trade in the field N1 and the reference index for this security in the field MI.

The field S enables the difference in performance between the considered security and the index to be determined. For example, in the region R1, the security does better than the reference index MI. At the point P5, the condition of sale is achieved if the index is below 2%. If a conditional order of sale had been entered, it would have been carried out at this moment (especially if the market is buying these securities).

Conversely in the region R2, the security evolves less than the reference index MI. At point P6, the purchase condition of a security is reached if the index is above 2%. If a conditional order of purchase had been entered, it would have been carried out at that moment (especially if the market is selling these securities).

This has a definite benefit over an absolute limit procedure. An order of sale will not be launched if the market is globally in evolution and that this evolution is following that of the security under consideration. This procedure enables a focus on the individual evolution of a security in relation to the general movement of the stock market. If a security rises in parallel with the index, selling it at that moment is not suggested. In order for it to become attractive for sale, the security has to perform better than the reference index.

This usual checks as described above can also be carried out in this case. A control on the existence of the market index will be carried out in order to avoid any data entry errors.

An extra safety measure is proposed as an option to the user in the specification of a limit on the purchase or on the sales price. When the stock market is undergoing wide variations it is possible to specify a limit, either above in case of a purchase, or below in case of a sale. If these limits are exceeded, the transaction is blocked.

In accordance with the first embodiment of the invention, when implementing two securities and the security targeted for purchase sees its value fall, the transaction is launched and the exchange of securities takes place. It is possible that the targeted security is experiencing an abnormal decreasing trend and its value doomed to a strong decline in the days ahead. In this case the purchase of such a security could prove to be inadequate in the medium term.

This is why it is possible to introduce a third variable which is the market index related to this security. If the security to be purchased is in a negative phase as regards the index, the transaction is not carried out.

This configuration is illustrated in FIG. 5, where, in addition to the securities and the quantities of securities for sale and for purchase and their targeted performance, two new fields are proposed to the user. The first field MI specifies the market index to verify (eg. NASDAQ) in the case of a purchase of a security and the field MP, the maximum tolerated difference between the evolution of the index and the security to be purchased. Before validating a purchase of a security, it is verified that its evolution as regards the reference point is not lower than the value specified by the user. This new parameter avoids the purchase of a security that was falling in value following an announcement of results far below the expectations of investors for example. If performance S is defined at 2% and if the maximum MP difference is defined as 2%, then the transaction could only take place when the security S1 to sell is at least equal to the MI index. The security to be purchased, S2, is therefore −2% as related to S1, the security to be sold (performance condition) and equal to a maximum of −2% of the index.

This configuration when performance S=limit of the MP index, forces the security for sale to be at least as well positioned as the market index.

Just as this limit is applied to the security to purchase, it is possible to also apply it to the security to be sold, with the objective of blocking a purchase transaction if the security had just registered a particularly good performance. This time the condition is reversed, ie. the order of sale is blocked if the evolution of the security for sale exceeds the reference index by a certain percentage.

Other implementation variations can be envisaged within the parameters of this invention. For example, a large number of successive orders could be placed for securities for sale and for securities for purchase. In a single data entry operation, the security for sale, the quantity, the security to purchase, the desired quantity and performance can all be entered.

Another embodiment enables the OR function on the security to be purchased. A first security is selected for the sale and two or more are selected for the purchase. Monitoring takes place between the first security and the second, and between the first security and the third and then on all the securities. When one or another of the required performance conditions are fulfilled, the transaction is generated and the other orders are cancelled.

Another embodiment enables an on-going functionality of when a transaction has been completed it is automatically re-initialized with the reversal of securities for sale and for purchase. So every time a trend changes direction, a transaction is launched. This can be observed on the diagram on FIG. 2 at point P1, where a first transaction is carried out. The difference of 2% between security A and security B is achieved. With the automatic refreshing of this combined order, a new transaction is launched at point P2, after a positive trend of security A is reversed as related to security B. In this type of procedure, the reference point, initially fixed at the start of the monitoring of the first transaction, can either be retained at that specific point for the rest of the monitoring process, or can be re-initialized at the moment of the first transaction. This last solution reverts to the restarting of a new transaction with a reversal of the securities to sell and to purchase.

This mechanism can also be applied on a version with more than two securities. At the outset, one tries to sell A securities in favor of securities B or C. Once one or the other conditions are fulfilled, for example, as regards C, A securities are sold in order to purchase C securities. From this point onwards, it is the security C which will be for sale and compared with the quotation values of securities A and B. In practice, one tries to specify a group of securities with similar performances in the same market sectors.

For safety reasons, it is possible to fix a validity deadline for all the transactions described above. It could of course happen that market conditions do not allow the optimum conditions to be met quickly. For example, the user can define a week as the waiting period for these conditions to occur. This period could be determined automatically by the system, taking into account the desired percentage gain. The higher the percentage, the longer the cancellation period. After this deadline has expired, the order is deleted from the database of the broker. A message alerts the user to this deadline, on the one hand when it is programmed and the other on expiry.

In a configuration where there are multiple securities involved, for example in a portfolio revision, it is possible to specify several securities for sale and their respective quantities. At the same time, the user specifies several securities to purchase according to a percentage-based distribution. When such an order is initialized, the application calculates the global value of the portfolio for sale, and according to the specified percentage for each new security, it determines the respective quantity.

The performance index fixed by the user operates, therefore, on the total values for each security. The difference between the securities for sale and for purchase is monitored at regular intervals. When the trading condition is reached, the simultaneous sale of all securities in the portfolio is launched and the purchase of the targeted securities is prescribed.

Other operations are carried out in order to guarantee the maintenance of the initial conditions. So if a dividend DA is paid to the security holders, this dividend enables a new performance criterion to be calculated:

P1: initial value of security A for sale

P3: current value of security A for sale (“bid price”)

N1: quantity of security A

P2: initial value of security for purchase

P4: current value of the security for purchase (“ask price”)

N2: quantity of security B

In the first case, the security sold received a dividend: DA. P3ex takes into account the value of security A after the charging of the dividend.

AS=(N1*(P3ex+DA))−(N2*P4)−(N1*P1−N2*P2)

In the second case, the security for purchase received a dividend DA. P4ex takes the value of security B into account after the charging of the dividend

AS=(N1*P3−N2*(P4ex+DA))−(N1*P1−N2*P2)

In the case of the splitting of a security, the trading conditions have to be recalculated. The security for sale is divided according to Spa parts. P3ex takes the value into account after the splitting.

AS=((N1*P3ex*Spa)−(N2*P4))−(N1*P1−N2*P2)

Splitting of a security. The security for purchase is divided according to Spa parts. P4ex takes the value into account after the splitting.

AS=((N1*P3ex)−(N2*P4ex*Spa))−(N1*P1−N2*P2)

1. Method of trading securities electronically, each security is defined by its symbol (S1, S2) and its quotation value (P1, P2, P3, P4), of a first security (S1) to be sold at a first initial quotation value (P1) with a defined initial quantity (N1) which represents a first initial global value (P1*N1) at a reference point, wherein it comprises the following steps:
a) definition of a second security (S2) to be acquired, for which one specifies a second quantity (N2) at a second initial quotation value (P2) representing a second initial global value (P2*N2) reference point,
b) definition of a trading condition (RS) representing a gain resulting from the sale of the first quantity (N1) of the first security (S1) and the purchase of the second quantity (N2) of the second security (S2) after an evolution in the time of the quotation values of the first and second security, allowing this gain (RS) to be realized, having understood that this gain would have been zero if the transaction had been conducted at the reference point,
c) monitoring of the current quotation value (P3) of the first security and the current quotation value (P4) of the second security,
d) calculation of the fictitious gain (AS) resulting from the sale of the first quantity (N1) at the current quotation value (P3) of the first security (S1) and of the purchase of the second quantity (N2) at the current value (P4) of the second security (S2),
e) if this fictitious gain (AS) is equal to, or exceeds, the value of the trading condition (RS), verification that all or part of the quantity (N1) of the first security is actually required by the bid market and if all or part of the second quantity (N2) of the second security is available on the ask market, and in the positive event,
f) simultaneous sale of all or part of the first quantity (N1) of the first security (S1) and purchase all or part of the second quantity (N2) of the second security (S2),
g) in the negative event, re-execute steps c) to e).

2. Method in accordance with claim 2, characterized in that, when a lower quantity (N1′) than the desired quantity (N1) is requested by the market, or a lower quantity (N2′) than the desired quantity (N2) is available on the market, then the double transaction of sale and purchase is carried out on this available quantity (N1′ or N2′), with the quantity of the other security being adjusted in order to respect the initial proportion between the first quantity (N1) and the second quantity (N2).

3. A method in accordance with claims 1 or 2, characterized in that, it comprises the following controls:
a control regarding the designation of the codes of the securities (S1, S2).
a control on the availability of the security to be sold within the portfolio of the security's owner,
a control on the comparison of two global values in order that the exchange of the first quantity (N1) of the first security (S1) with the second quantity (N2) of the second security (S2) retains a similar value,
a control regarding the desired performance criterion S according to a pre-specified range of values.

4. A method in accordance with claims 1 or 2, characterized in that it comprises the following steps:
b′) definition of a market index (MI) and a safety index (MP) representing the evolution of the index (MI) as regards the quotation value of the second security (S2) in relation to a reference point,
d′) comparison of the evolution of the quotation value of the second security (S2) with the evolution of the index (MI), and the verification that the difference between the evolution of the index and the evolution of the quotation value of the second security is below the safety index (MP).

5. Method in accordance with the claims 1 or 2, characterized in that, the second security for acquisition (S2) being replaced by a multitude of securities (S2 . . . Sn) for acquisition, each of these securities is specified by a quantity (N2 . . . Nn) at an initial quotation value (P2 . . . Pn) representing an initial global value (P2*N2 . . . Pn*Nn), and in that, the monitoring of the quotations, the calculation of the fictitious gain (AS) and the conditions of quantity availability on the stock market (ask, bid) are made successively between the first security (S1) and each security for acquisition (S2 . . . Sn), and when one of the securities for acquisition fulfills these conditions, there is a simultaneous sale of all or part of the first quantity (N1) of the first security (S1) and the purchase of all or part of the quantity (Nn) of the second security (Sn) fulfilling these conditions.

6. Method in accordance with claims 1 or 2, characterized in that, when a completed simultaneous sale and purchase has been executed, one re-initializes the method in which the first security (S1) is now monitored in view of its acquisition and the security previously acquired (S2 . . . Sn) is now being monitored in view of its sale.

7. Method in accordance with claim 5, characterized in that, when a completed simultaneous sale and purchase has been executed, one re-initializes the method in which the first security (S1) is now monitored in view of its acquisition and the security previously acquired (S2 . . . Sn) is now being monitored in view of its sale.

8. Method in accordance with claim 6, characterized in that, a new reference point is defined corresponding to the moment when the sale and the purchase have been carried out simultaneously.

9. Method in accordance with claim 7, characterized in that, a new reference point is defined corresponding to the moment when the sale and the purchase have been carried out simultaneously.

10. Method in accordance with claims 1 or 2, characterized in that, the steps c) to e) are carried out at intervals whose length decrease as the condition, while approaching of the condition where the fictitious gain (AS) becomes equal to the trading condition (RS).

11. Method for trading securities electronically for a first security (S1) for sale or to purchase, for which a first quantity (N1) is specified and characterized by the following steps:
a) definition of a market index (MI) and a performance index (S) representing the evolution of the index (MI) as regards the quotation value of the security under consideration (S1) according to a reference point,
b) monitoring of the quotation value of the security (S1) and calculating the evolution of such quotation value as regards the reference point,
c) comparison of the evolution of security (S1) with the evolution of the index (MI),
d) if one wanted to purchase the security (S1), it should be verified that the difference between the evolution of the index and the evolution of the quotation value of the security is higher than the performance index (S),
if one wanted to sell security (S1), it should be verified that the difference between the evolution of the quotation value of the security and the evolution of the index is higher than the performance index (S), and in the positive event,
e) purchase or sell a first quantity (N1) of security (S1),
f) in the negative event, re-execute the steps b) to d).

12. Method according to claim 10, characterized in that, it further comprises the step of defining an absolute limits in the value of the security to be sold or purchased, outside of which the transaction is blocked.

13. Method in accordance with claims 11 or 12, characterized in that, the steps b) to d) are carried out at intervals whose length decrease as the condition, while approaching of the point where of the purchase or sell condition is meet.
